(19) United States
(12) Patent Application Publication
(10) Pub. No.: US 2025/0163861 A1
(43) Pub. Date: May 22, 2025

(54) INTERNAL COMBUSTION ENGINE

(71) Applicant: TOYOTA JIDOSHA KABUSHIKI KAISHA, Toyota-shi (JP)

(72) Inventor: Junpei SHOUJI, Toyota-shi (JP)

(21) Appl. No.: 18/916,710

(22) Filed: Oct. 16, 2024

(30) Foreign Application Priority Data
Nov. 21, 2023 (JP) 2023-197278

(51) Int. Cl. F02D 41/00

(52) U.S. Cl. CPC F02D 41/0002; F02D 2200/023; F02D 2200/0404; F02D 2200/101

(57) ABSTRACT

An internal combustion engine includes an intake passage, a throttle valve provided in the intake passage, a flow rate regulating valve provided at a downstream side of the throttle valve in the intake passage, a first passage that connects a crankcase to a section of the intake passage between the throttle valve and the flow rate regulating valve, and a second passage that connects the crankcase to a section of the intake passage at a downstream side of the flow rate regulating valve.

### CROSS-REFERENCE TO RELATED APPLICATIONS

This application is based upon and claims the benefit of priority from prior Japanese Patent Application No. 2023-197278, filed on Nov. 21, 2023, the entire contents of which are incorporated herein by reference.

### BACKGROUND

### 1. Field

The present disclosure relates to an internal combustion engine.

### 2. Description of Related Art

For example, Japanese Laid-Open Patent Publication No. 2006-132360 discloses

an internal combustion engine that includes a flow rate regulating valve, which is provided in the intake passage, a first passage, which connects the crankcase to a section of the intake passage at the upstream side of the flow rate regulating valve, and a second passage, which connects the crankcase to a section of the intake passage at the downstream side of the flow rate regulating valve. By adjusting the opening degree of the flow rate regulating valve, a blow-by gas treatment for drawing blow-by gas in the crankcase to the intake passage is performed.

In the internal combustion engine described in Japanese Laid-Open Patent Publication No. 2006-132360, the intake air amount is adjusted by using a complicated mechanism such as a variable valve actuation mechanism. Therefore, it is desired to treat the blow-by gas while adjusting the intake air amount of the internal combustion engine with a simpler configuration.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an internal combustion engine includes an intake passage, a throttle valve provided in the intake passage, a flow rate regulating valve provided at a downstream side of the throttle valve in the intake passage, a first passage that connects a crankcase to a section of the intake passage between the throttle valve and the flow rate regulating valve, and a second passage that connects the crankcase to a section of the intake passage at a downstream side of the flow rate regulating valve.

Other features and aspects will be apparent from the following detailed description, the drawings, and the claims.

### BRIEF DESCRIPTION OF THE DRAWINGS

FIG. 1 is a schematic diagram showing the configuration of an internal combustion engine according to one embodiment.

FIG. 2 is a flowchart showing a procedure of a process executed by the controller according to the embodiment.

FIG. 3 is a flowchart showing a procedure of processes executed by a controller according to a modification of the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Hereinafter, an embodiment of an internal combustion engine mounted on a vehicle will be described.

### Configuration of Internal Combustion Engine

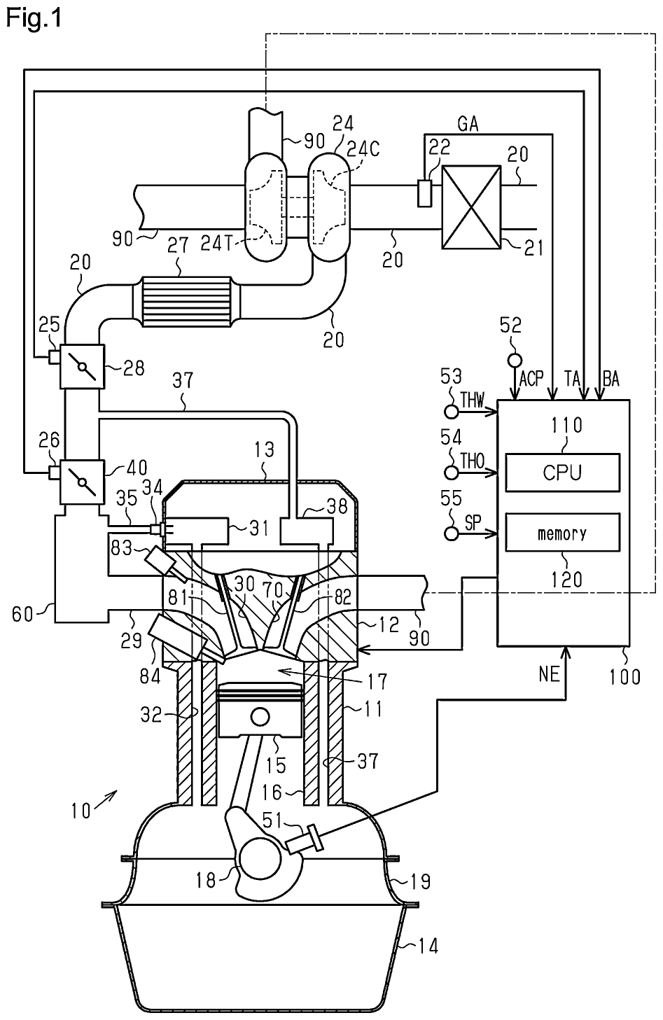

As shown in FIG. 1, the internal combustion engine 10 includes a cylinder block 11, a cylinder head 12, a head cover 13, and an oil pan 14. The cylinder block 11 includes a cylinder 16, in which a piston 15 is disposed to reciprocate.

The cylinder head 12 is provided with an intake port 30 for introducing intake air into the combustion chamber 17 of the internal combustion engine 10 and an exhaust port 70 for discharging exhaust gas from the combustion chamber 17. The intake port 30 is provided with an intake valve 81. The exhaust port 70 is provided with an exhaust valve 82.

The cylinder head 12 is provided with a port injection valve 83, a direct injection valve 84, and a spark plug (not shown). The port injection valve 83 injects hydrogen gas as the engine fuel into the intake port 30. The direct injection valve 84 directly injects hydrogen gas, which is engine fuel, into the combustion chamber 17.

A crankcase 19 is provided below the cylinder block 11. The crankcase 19 accommodates a crankshaft 18, which is an output shaft of the internal combustion engine 10. The oil pan 14, which stores lubricant, is provided below the crankcase 19.

An intake manifold 29, which includes a surge tank 60, is connected to the upstream side of intake port 30. The intake pipe 20 is connected to the upstream of the surge tank 60. The intake pipe 20, the surge tank 60, and the intake manifold 29 constitute an intake passage of the internal combustion engine 10.

The intake pipe 20 is provided with an air cleaner 21, a compressor wheel 24C, an intercooler 27, a throttle valve 28, and a flow rate regulating valve 40 in this order from the upstream side. The compressor wheel 24C constitutes a forced-induction device 24 that is driven using the exhaust gas discharged from the combustion chamber 17.

The throttle valve 28 adjusts the intake air amount of the internal combustion engine 10. The throttle valve 28 includes a butterfly valve that is rotated by an electric motor. By rotating the butterfly valve, the opening degree of the throttle valve 28 is changed.

The flow rate regulating valve 40 adjusts the flow rate of the blow-by gas introduced into the intake passage from the crankcase 19. The opening degree of the flow rate regulating valve 40 is changed by the electric motor. The flow rate regulating valve 40 of the present embodiment has the same valve structure as the throttle valve 28, but may have a different valve structure.

The air cleaner 21 filters intake air taken into the intake pipe 20. The forced-induction device 24 compresses air in the intake pipe 20. The intercooler 27 cools the air that has passed through the compressor wheel 24C.

An exhaust passage 90 is connected to the downstream side of the exhaust port 70. A housing that accommodates a turbine wheel 24T of the forced-induction device 24 is connected to an intermediate portion of the exhaust passage 90.

The internal combustion engine 10 is provided with a blow-by gas treating device, which treats gas leaking from the combustion chamber 17 into the crankcase 19 during a compression stroke or a combustion stroke, that is, so-called blow-by gas.

The blow-by gas treatment device includes a fresh air introduction passage 37 for introducing fresh air into the crankcase 19 and scavenging the fresh air. One of both ends of the fresh air introduction passage 37 is connected to the intake pipe 20 between the throttle valve 28 and the flow rate regulating valve 40. The fresh air introduction passage 37 penetrates the head cover 13, passes through the inside of the cylinder head 12 and the cylinder block 11, and is connected to the crankcase 19. A separator 38, which is an oil separator installed in the head cover 13, is provided in the middle of the fresh air introduction passage 37. The fresh air introduction passage 37 and the separator 38 constitute a first passage that communicates the intake passage between the throttle valve 28 and the flow rate regulating valve 40 with the crankcase 19.

The blow-by gas treatment device includes a suction passage 32 for guiding the blow-by gas in the crankcase 19 to a separator 31 which is an oil separator provided in the head cover 13. An end of the suction passage 32 connected to the separator 31 opens into the crankcase 19. The separator 31 may be provided in the middle of the suction passage 32.

The separator 31 is connected to the surge tank 60 via a positive crankcase ventilation (PCV) valve 34, which is a differential pressure valve, and a PCV passage 35. When the pressure in the surge tank 60 becomes lower than the pressure in the separator 31, the PCV valve 34 opens to allow the blow-by gas to flow from the separator 31 into the surge tank 60. The suction passage 32, the separator 31, the PCV valve 34, and the PCV passage 35 constitute a second passage that communicates the intake passage downstream of the flow rate regulating valve 40 with the crankcase 19.

Fresh air is introduced into the crankcase 19 via the fresh air introduction passage 37. Further, when the opening degree of the flow rate regulating valve 40 is adjusted to be small, the pressure on the downstream side of the flow rate regulating valve 40 in the intake pipe 20 decreases. When the pressure on the downstream side of the flow rate regulating valve 40 decreases, the blow-by gas in the crankcase 19 is introduced into the intake pipe 20 via the suction passage 32 together with the fresh air. The blow-by gas drawn into the intake pipe 20 is delivered to the combustion chamber 17 together with the intake air and burned therein.

The controller 100 controls the internal combustion engine 10, and operates various operation target devices such as the throttle valve 28, the flow rate regulating valve 40, the port injection valve 83, the direct injection valve 84, and the spark plug.

The controller 100 includes a CPU110 that performs arithmetic processing, a memory 120 that stores programs and date for control, and the like. The controller 100 executes processing related to various types of control by the CPU110 executing a program stored in the memory 120.

Detection signals of an air flow meter 22 that detects an intake air amount GA, a throttle sensor 25 that detects a throttle opening degree TA that is an opening degree of the throttle valve 28, and a valve opening degree sensor 26 that detects a valve opening degree BA that is an opening degree of the flow rate regulating valve 40 are input to the controller 100. Further, a detection signal of a crank angle sensor 51 that detects a rotation angle (crank angle) of the crankshaft 18 is input to the controller 100 in order to calculate an engine rotation speed NE. Further, a detection signal of an accelerator operation amount sensor 52 that detects an accelerator operation amount ACP that is an operation amount of an accelerator pedal is input to the controller 100. The controller 100 also receives detection signals from a water temperature sensor 53 that detects a coolant temperature THW, which is the temperature of the cooling water of the internal combustion engine 10, and an oil temperature sensor 54 that detects an oil temperature THO, which is the temperature of the lubricating oil of the internal combustion engine 10. The coolant temperature THW is an engine water temperature. The oil temperature THO is an engine oil temperature. The controller 100 also receives a detection signal from a vehicle speed sensor 55 that detects a vehicle speed SP of the vehicle on which the internal combustion engine 10 is mounted. The controller 100 calculates an engine load factor KL based on the engine rotation speed NE and the intake air amount GA. The engine load factor KL is a parameter that determines the amount of air filling the combustion chamber 17, and is the ratio of the inflow air amount per combustion cycle in one cylinder to a reference inflow air amount. The reference inflow air amount may be varied in accordance with the engine rotation speed NE.

The range of a combustible air-fuel mixture of hydrogen gas as an engine fuel is wider than that of gasoline. For this reason, the hydrogen gas can be combusted even in a lean mixture. Therefore, the controller 100 performs the following output control.

That is, the controller 100 calculates a target output Pe, which is a target value of the output required for the internal combustion engine 10, based on the accelerator operation amount ACP and the vehicle speed SP. When the target output Pe is large, the controller 100 executes control to make the air-fuel ratio of the air-fuel mixture smaller than when the target output Pe is small. More specifically, the controller 100 basically maintains the throttle valve 28 at an opening degree equal to or larger than a predetermined value, for example, an opening degree close to a fully opened state. Then, the controller 100 sets the required injection amount Qd such that the required injection amount Qd increases as the target output Pe increases. The required injection amount Qd is a target value of the fuel injected from the port injection valve 83 and the direct injection valve 84. Then, the controller 100 controls the port injection valve 83 and the direct injection valve 84 such that the required injection amount Qd is obtained. In this way, in the internal combustion engine 10, the output adjustment is performed by changing the air-fuel ratio of the air-fuel mixture through the adjustment of the fuel injection amount.

### Control of Opening Degree of Flow Rate Regulating Valve

The engine fuel of the internal combustion engine 10 is hydrogen gas, which is gas fuel. Therefore, the ratio of hydrogen molecules in the engine fuel is larger than that in the case of gasoline or the like which is liquid fuel. Therefore, the amount of moisture contained in the blow-by gas also increases. When the state in which the internal combustion engine 10 is not warmed up continues, the temperature in the crankcase 19 does not rise. Therefore, condensed water derived from moisture contained in the blow-by gas is likely to be generated in the crankcase 19. Then, the condensed water is mixed into the lubricating oil stored in the oil pan 14, for example, in the crankcase 19.

Therefore, the controller 100 scavenges the blow-by gas in the crankcase 19 through the opening degree control of the flow rate regulating valve 40.

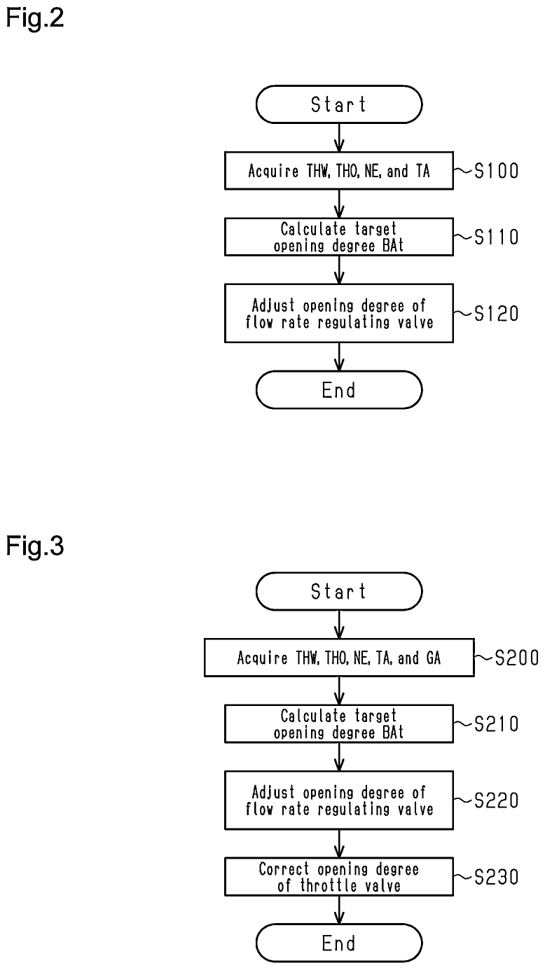

FIG. 2 shows a processing procedure for controlling the opening degree of the flow rate regulating valve 40. The processing shown in FIG. 2 is realized by the CPU110 repeatedly executing a program stored in the memory 120 of the controller 100 at predetermined intervals. In the following description, the number of each step is represented by the letter S followed by a numeral.

In the series of processes shown in FIG. 2, the controller 100 acquires the coolant temperature THW, the oil temperature THO, the engine rotation speed NE, and the throttle opening degree TA (S100).

Next, the controller 100 executes a process of calculating a target opening degree BAt, which is a target value of the opening degree of the flow rate regulating valve 40, based on the coolant temperature THW, the oil temperature THO, the engine rotation speed NE, and the throttle opening degree TA (S110).

When the coolant temperature THW or the oil temperature THO is low, the amount of condensed water generated in the crankcase 19 increases. Therefore, it is desirable to increase the amount of blow-by gas introduced into the intake pipe 20 from the inside of the crankcase 19. Therefore, the controller 100 calculates the target opening degree BAt such that the value of the target opening degree BAt decreases as the coolant temperature THW decreases. Further, the controller 100 calculates the target opening degree BAt such that the value of the target opening degree BAt decreases as the oil temperature THO decreases.

The engine rotation speed NE is a value related to the amount of blow-by gas in the crankcase 19. As the engine rotation speed NE increases, the amount of blow-by gas flowing into the crankcase 19 increases. Therefore, it is desirable to increase the amount of blow-by gas introduced into the intake pipe 20 from the inside of the crankcase 19.

However, if the amount of blow-by gas is increased in this way, the amount of intake air may become insufficient. Therefore, the controller 100 calculates the target opening degree BAt according to the engine rotation speed NE while considering the balance between the amount of the blow-by gas introduced into the intake pipe 20 and the intake air amount.

Further, when the amount of intake air required of the internal combustion engine 10 is large and the opening degree of the throttle valve 28 is made larger, if making the opening degree of the flow rate regulating valve 40 smaller, the amount of intake air may become insufficient. Therefore, the controller 100 calculates the target opening degree BAt corresponding to the throttle opening degree TA while considering the balance between the amount of the blow-by gas introduced into the intake pipe 20 and the intake air amount.

The controller 100 calculates the target opening degree BAt based on map data indicating a relationship between the coolant temperature THW, the oil temperature THO, the engine rotation speed NE, and the throttle opening degree TA and the target opening degree BAt, an arithmetic expression, or the like.

Next, the controller 100 adjusts the opening degree of the flow rate regulating valve 40 such that the opening degree BA and the target opening degree BAt coincide with each other (S120). Then, the controller 100 ends the execution of this process in the current execution cycle.

### Operation and Advantages of Present Embodiment

(1) The internal combustion engine 10 includes the intake passage, the throttle valve 28 provided in the intake passage, and the flow rate regulating valve 40 provided in a section of the intake passage at the downstream side of the throttle valve 28. Further, the internal combustion engine 10 includes the first passage, which connects the crankcase 19 to the section of the intake passage between the throttle valve 28 and the flow rate regulating valve 40, and the second passage, which connects the crankcase 19 to the section of the intake passage at the downstream side of the flow rate regulating valve 40. Therefore, fresh air is introduced into the crankcase 19 via the first passage. By adjusting the opening degree of the flow rate regulating valve 40, the blow-by gas in the crankcase 19 is drawn into the intake passage via the second passage together with the fresh air. Further, the intake air amount of the internal combustion engine 10 is adjusted by adjusting the opening degree of the throttle valve 28. Accordingly, it is possible to treat the blow-by gas while adjusting the intake air amount of the internal combustion engine 10 with a simple configuration compared to a case in which a variable valve actuation mechanism is used.
(2) The internal combustion engine 10 includes the controller 100, which adjusts the opening degree of the flow rate regulating valve 40. The controller 100 executes the process of adjusting the opening degree of the flow rate regulating valve 40 based on the coolant temperature THW, the oil temperature THO, the engine rotation speed NE, and the throttle opening degree TA, as described above. Accordingly, the opening degree of the flow rate regulating valve 40 is set appropriately.
(3) As described above, when the fuel of the internal combustion engine 10 is gas fuel, the ratio of hydrogen molecules in the fuel is higher than that in the case of gasoline or the like, which is liquid fuel. Therefore, the amount of water contained in the blow-by gas also increases, and thus condensed water is likely to be generated in the crankcase 19. In this regard, in the present embodiment, it is possible to scavenge the blow-by gas in the crankcase 19 by adjusting the opening degree of the flow rate regulating valve 40. Therefore, in the internal combustion engine 10 using gas fuel, with which condensed water is likely to be generated in the crankcase 19, the generation of the condensed water is suppressed.

### Modifications

The above-described embodiment may be modified as follows. The above-described embodiment and the following modifications can be combined as long as the combined modifications remain technically consistent with each other.

When the opening degree of the flow rate regulating valve 40 is adjusted, the intake air amount of the internal combustion engine 10 changes. Therefore, the controller 100 may execute a process of correcting the opening degree of the throttle valve 28 so as to suppress the change in the intake air amount due to the adjustment of the opening degree of the flow rate regulating valve 40.

FIG. 3 shows a processing procedure for controlling the opening degree of the flow rate regulating valve 40 in this modification. The processing shown in FIG. 3 is realized by the CPU110 repeatedly executing a program stored in the memory 120 of the controller 100 at predetermined intervals.

In the series of processes shown in FIG. 3, the controller 100 acquires the coolant temperature THW, the oil temperature THO, the engine rotation speed NE, the throttle opening degree TA, and the intake air amount GA (S200).

Next, the controller 100 executes a process of calculating a target opening degree BAt, which is a target value of the opening degree of the flow rate regulating valve 40, based on the coolant temperature THW, the oil temperature THO, the engine rotation speed NE, and the throttle opening degree TA (S210). This S210 process is identical to the S110 process described above.

Next, the controller 100 adjusts the opening degree of the flow rate regulating valve 40 such that the opening degree BA and the target opening degree BAt coincide with each other (S220). This S220 process is identical to the S120 process described above.

Next, the controller 100 executes a process of correcting the opening degree of the throttle valve 28 (S230). In the S230 processing, the controller 100 executes the following processing. That is, the controller 100 acquires the intake air amount GA after the opening degree of the flow rate regulating valve 40 is adjusted in the S220 process. Then, the controller 100 corrects the opening degree of the throttle valve 28 so that the acquired intake air amount GA becomes equal to the intake air amount GA acquired in the process of S200, that is, the intake air amount GA before the opening degree of the flow rate regulating valve 40 is adjusted.

Then, the controller 100 ends the execution of this process in the current execution cycle.

According to this modification, since the process of correcting the opening degree of the throttle valve 28 is executed so as to suppress a change in the intake air amount due to the adjustment of the opening degree of the flow rate regulating valve 40, it is possible to suppress such a change in the intake air amount.

As a modification of the S230 process, the controller 100 may execute the following process. That is, the controller 100 may correct the opening degree of the throttle valve 28 so that the intake air amount GA after adjusting the opening degree of the flow rate regulating valve 40 becomes equal to the intake air amount required for the internal combustion engine 10.

The controller 100 may execute a process of adjusting the opening degree of the flow rate regulating valve 40 based on at least one of the coolant temperature THW, the oil temperature THO, the engine rotation speed NE, and the throttle opening degree TA.

The phrase “at least one of” as used in this disclosure means “one or more” of a desired choice. For one example, the phrase “at least one of” as used in this disclosure means “only one single choice” or “both of two choices” if the number of its choices is two. In another example, the phrase “at least one of” as used in this description means “only one single option” or “any combination of two or more options” if the number of options is three or more.

Although the suction passage 32 is connected to the surge tank 60, the connection site may be changed as appropriate as long as it is a site downstream of the flow rate regulating valve 40 in the intake passage.

The internal combustion engine 10 may include only one of the port injection valve 83 and the direct injection valve 84.

It is not essential that the internal combustion engine 10 includes the forced-induction device 24.

It is not essential for the internal combustion engine 10 to include the PCV valve 34.

Gas fuel such as LPG or CNG may be used as the engine fuel of the internal combustion engine 10.

Liquid fuel such as gasoline, light oil, or alcohol fuel may be used as the engine fuel of the internal combustion engine 10. Even in this case, the operations and effects described in the above (1) and (2) can be obtained.

The controller is not limited to a device that includes the CPU 110 and the memory 120, and executes software processing. For example, at least part of the processes executed by the software in the above-described embodiment may be executed by hardware circuits dedicated to executing these processes (such as an application-specific integrated circuit (ASIC)). That is, the controller may be modified as long as it has any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. One or any desired number of software processing devices that each include a processor and a program storage device and one or any desired number of dedicated hardware circuits may be provided.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An internal combustion engine, comprising:
an intake passage;
a throttle valve provided in the intake passage;
a flow rate regulating valve provided at a downstream side of the throttle valve in the intake passage;
a first passage that connects a crankcase to a section of the intake passage between the throttle valve and the flow rate regulating valve; and
a second passage that connects the crankcase to a section of the intake passage at a downstream side of the flow rate regulating valve.

2. The internal combustion engine according to claim 1, further comprising a controller that adjusts an opening degree of the flow rate regulating valve,
wherein the controller includes a processing circuitry configured to execute a process of adjusting the opening degree of the flow rate regulating valve based on at least one of an engine coolant temperature, an engine oil temperature, an engine rotation speed, and an opening degree of the throttle valve.

3. The internal combustion engine according to claim 2, wherein the processing circuitry is configured to execute a process of correcting the opening degree of the throttle valve to suppress a change in an intake air amount that accompanies adjustment of the opening degree of the flow rate regulating valve.

4. The internal combustion engine according to claim 1, wherein a fuel of the internal combustion engine is gas fuel.
